(19) United States
(12) Patent Application Publication
(10) Pub. No.: US 2014/0353183 A1
(43) Pub. Date: Dec. 4, 2014

(54) CONTAINER WITH CALORIC MARKINGS

(71) Applicant: Cooper Innovations LLC, North Canton, OH (US)

(72) Inventors: Kyle Cooper, North Canton, OH (US); Chris Hawker, Columbus, OH (US); Chris Brown, Columbus, OH (US); Matt Seibert, Columbus, OH (US); Nick Vallo, New Albany, OH (US); Joel Beebe, Columbus, OH (US)

(21) Appl. No.: 13/907,816

(22) Filed: May 31, 2013

(51) Int. Cl. A47G 19/12; B67D 3/00; A47G 21/00

(52) U.S. Cl. CPC A47G 19/127; A47G 21/007; B67D 3/0074; A47G 2021/008; A47G 2200/163; B67D 2210/00118; A47G 2400/06
USPC 206/232; 206/459.1; 206/459.5

(57) ABSTRACT

A container is described for holding and dispensing chilled fluids for consumption by a user. The container may include a temperature indicating device configured to indicate whether a current temperature of liquid is at or below a first temperature value. The container may include a plurality of gradations configured to indicate a plurality of liquid levels in the enclosed chamber. Each pair of the plurality of liquid level gradations may have a corresponding volume. A plurality of caloric indicia may be displayed in conjunction with the plurality of gradations. Each caloric indicia may display a caloric energy value corresponding to heating one or more of the volumes of aqueous liquid from the first temperature value to a second temperature value. The container may be included in a kit with instructions directing a user in operation of the container, for example, as part of a diet or regimen of physical fitness.

### BACKGROUND

Unless otherwise indicated herein, the materials described in this section are not prior art to the claims in this application and are not admitted to be prior art by inclusion in this section.

Consuming water or other liquids below a certain temperature may cause the human body to burn calories because the body may heat the water to effectively use it in the digestive system. Tests have shown and formulas have been developed indicating the amount of calories that the body may expend upon drinking various quantities of water at various temperatures. Although the increased amount of calories expended may be small for a chilled 8 ounce glass of water, daily water consumption may total a significant amount of calories. For example, an individual consuming the recommended eight 8 ounce glasses of water, sufficiently chilled, may expend an additional 70 kilocalories per day which may result in weight loss over time. Others have reported that digestion of cooled water may result in an increase in metabolism due to the body expending more energy to heat the cooler water before ingesting it into the digestive system of the individual. Although this phenomenon is known, no one has effectively and conveniently used it to assist individuals to lose weight.

A need exists for a container and method of use which provides an indication to an individual as to the amount of kilocalories that may be expended upon drinking a certain quantity of water from the container assuming that the contents of the container may be within a certain temperature range confirmed by a temperature indicator on the container.

The present application appreciates that managing personal caloric balance may be a challenging endeavor.

### SUMMARY

The following summary is illustrative only and is not intended to be in any way limiting. In addition to the illustrative aspects, embodiments, and features described above, further aspects, embodiments, and features will become apparent by reference to the drawings and the following detailed description.

In various embodiments, a container is provided. The container may include a dual wall, the dual wall may include an external wall coupled to an internal wall. The internal wall may define an enclosed chamber configured to contain aqueous liquid therein. The external wall may enclose the internal wall to define an insulating space between the external wall and the internal wall. The external wall may include a base configured to support the container on a surface. The container may include a port traversing the dual wall and the insulating space. The port may be configured to admit aqueous liquid from outside the external wall into the enclosed chamber. The container may include an output spigot traversing the dual wall and the insulating space. The output spigot may be configured to dispense aqueous liquid contained within the chamber from the container. The container may include a temperature indicating device displayed on the container. The temperature indicating device may be configured to indicate to a user whether a current temperature of aqueous liquid contained in the chamber may be at or below a first temperature value. The container may include a plurality of gradations displayed on the container and configured to indicate to a user a plurality of liquid levels in the enclosed chamber. Each pair of the plurality of liquid level gradations may have a corresponding volume. The container may include a plurality of caloric indicia displayed in conjunction with the plurality of gradations. Each caloric indicia may display a caloric energy value corresponding to heating one or more of said corresponding volumes of aqueous liquid from the first temperature value to a second temperature value.

In several embodiments, a container is provided. The container may include a dual wall. The dual wall may include an external wall coupled to an internal wall. The internal wall may define an enclosed chamber configured to contain aqueous liquid therein. The external wall may enclose the internal wall to define an insulating space between the internal wall and the external wall, and the external wall may include a base configured to support the container on a surface. The container may include a port traversing the dual wall and the insulating space. The port may be configured to convey aqueous liquid between the enclosed chamber and the outside of the container. The container may include a temperature indicating device displayed on the container. The temperature indicating device may be configured to indicate to a user whether a current temperature of aqueous liquid contained in the chamber may be at or below a first temperature. The first temperature may be below about 37° C. The container may include a plurality of gradations displayed on the container and configured to indicate to a user a plurality of liquid levels in the enclosed chamber. Each pair of the plurality of liquid level gradations may have a corresponding volume. The container may include a plurality of caloric indicia displayed in conjunction with the plurality of gradations. Each caloric indicia may display a caloric energy value corresponding to heating one or more of said corresponding volumes of aqueous liquid from the first temperature to about 37° C. The container may include a vent located in the external wall. The vent may be operable to control an exchange of air between the insulating space and the atmosphere outside the external wall. The vent may be operable to modulate an insulating value of the insulating space.

In some embodiments, a kit is provided. The kit may include a container and instructions. In the kit, the container may include a dual wall including an external wall coupled to an internal wall. The internal wall may define an enclosed chamber configured to contain aqueous liquid. The external wall may enclose the internal wall to define an insulating space between the external wall and the internal wall. The external wall may include a base configured to support the container on a surface. The container may include a port traversing the dual wall and the insulating space. The port may be configured to convey aqueous liquid between the enclosed chamber and the outside of the container. The container may include a temperature indicating device displayed on the container. The temperature indicating device may be configured to indicate to a user whether a current temperature of aqueous liquid contained in the chamber may be at or below a first temperature. The first temperature may be below about 37° C. The container may include a plurality of gradations displayed on the container and configured to indicate to a user a plurality of liquid levels in the enclosed chamber. Each pair of the plurality of liquid level gradations may have a corresponding volume. The container may include a plurality of caloric indicia displayed in conjunction with the plurality of gradations. Each caloric indicia may display a caloric energy value corresponding to heating one or more of the corresponding volumes of aqueous liquid from the first temperature to about 37° C.

In the kit, the instructions may be displayed on one or more of the container, an instructional sheet provided with the container, and/or a packaging material for the container. The instructions may direct a user to add an aqueous liquid to the container. The instructions may direct a user to cool the container below about 37° C. until the temperature indicator indicates that the current temperature of aqueous liquid contained in the chamber may be at or below the first temperature. The instructions may direct a user to consume the aqueous liquid at or below the first temperature.

### BRIEF DESCRIPTION OF THE DRAWINGS

The accompanying figures, which are incorporated in and constitute a part of the specification, illustrate various example apparatuses, systems, and methods, and are used merely to illustrate various example embodiments.

FIG. 1 is a side elevation view of an example container filled with a liquid.

FIG. 2 is a diagrammatic perspective view showing an example container being inserted into a refrigerator or similar refrigeration device.

FIG. 3 is a diagrammatic perspective view showing an example container inside of a refrigeration unit with a temperature indicating device indicating that the liquid may be at a first temperature.

FIG. 4 is a sectional view of the refrigeration unit showing liquid being dispensed from the container to a certain printed indicia level while the liquid may be maintained at the first temperature.

FIG. 5 is a cross-sectional view of an example container.

FIG. 6 is a plan view of an example container.

FIG. 7 is an exploded view of an example container.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be employed, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

This disclosure is generally drawn, inter alia, to containers, methods, apparatus, systems, kits, and/or instructions related to consumption of chilled water to incur a caloric energy debt in a user as part of a diet or physical fitness regimen.

Briefly stated, the invention may include a container that has an inverted “Calories Burned” caloric indicia or scale that corresponds to the caloric difference between an indicated volume of water at or below a predetermined first temperature and the same volume of water at physiological temperature, i.e., °37° C. The scale may be linked to a temperature indicating device that may change color or otherwise let the user know that the water may be cold enough, e.g. at about the first temperature or less. The heat capacity of liquid water may be approximated as one calorie to raise one milliliter of water one degree Celsius. Accordingly, the caloric energy content referred to in the caloric indicia may be calculated by multiplying the volume of water or other aqueous liquid in a given volume in milliliters by the temperature difference between the first temperature of the water or other aqueous liquid and the temperature it may be warmed to, e.g., 37° C., and dividing by 1000 to convert to conventional food calories or kilocalories.

In some examples, the volume of the container may be approximately 3 liters (or 100 kilocalories of energy debt at a common refrigerator temperature of about 4° C. or less). This happens to be between 5 and 6 common water bottles worth of water. In one embodiment, this arrangement yields results of about 1 kilocalorie burned per 1 fl. oz. of cold water. For perspective, the Mayo Clinic website states that the ideal (minimum) amount of water to drink each day may be 13 (8 oz.) cups for men and 9 (8 oz.) cups for women.

A user may fill the container and put it in a refrigerator to cool. The temperature indicating device may be activated and the water may be at the first temperature. The user may pour and drink water or another aqueous fluid, such as tea, which may be chilled to about the first temperature or less. For each day that a user may finish the container, the user's body may burn a cumulative energy debt of additional kilocalories to maintain proper body temperature, e.g., about 100 kilocalories per day. A daily caloric energy debt of 100 kilocalories per day converts to approximately 10.4 lbs. lost per year, based on 3500 kilocalories per pound of body fat. The cold water or other fluid may absorb the body's thermal energy upon ingestion. Since that fluid may leave the body at or near core body temperature due to excretion or evaporation, the fluid may take a corresponding portion of thermal energy out of the body.

In various examples, the design may be convenient for the user. The caloric indicia scale may start at zero when the container is full, and may increase cumulatively according to the volume of liquid dispensed from the container. The caloric indicia scale may be inverted so that at any point, without having to keep track, the user may view his/her progress in terms of food calories over a day or other period of time. Also, in the case that the user cannot or chooses not to drink the full container, the user may aim for a different value, e.g., 50 kilocalories burned per day and fill it every two days instead. The individual plan may be customized by each user as desired.

Normally, to increase one's metabolism for weight loss, users may employ physical exercise where the amount of kilocalories burned may be linked to body size. However, with use of the present invention, the amount of energy burned corresponds to the chilled water's capacity to absorb thermal energy and has no relation to a person's size, but rather the volume and temperature of water consumed over time.

In some examples, a benefit of the present invention may be that it may complement rather than compete with existing diet, exercise, and other weight loss plans. The container may be affordably priced and may be re-used without expensive consumable supplies. Effective user operation may employ very little time and effort to reap the benefits, which may tend to increase diet sustainability over long periods of time, in contrast to typical diet or exercise plans. Moreover, the caloric indicia on the container may provide instant feedback as to progress in accumulating a caloric energy debt corresponding to increased bodily energy expenditure.

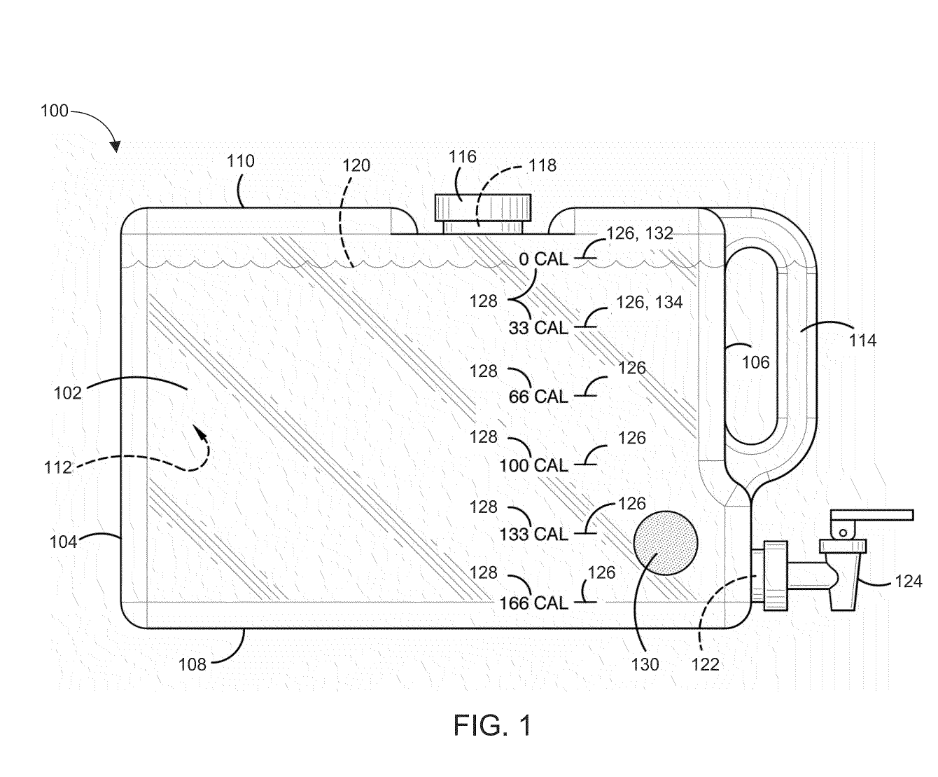

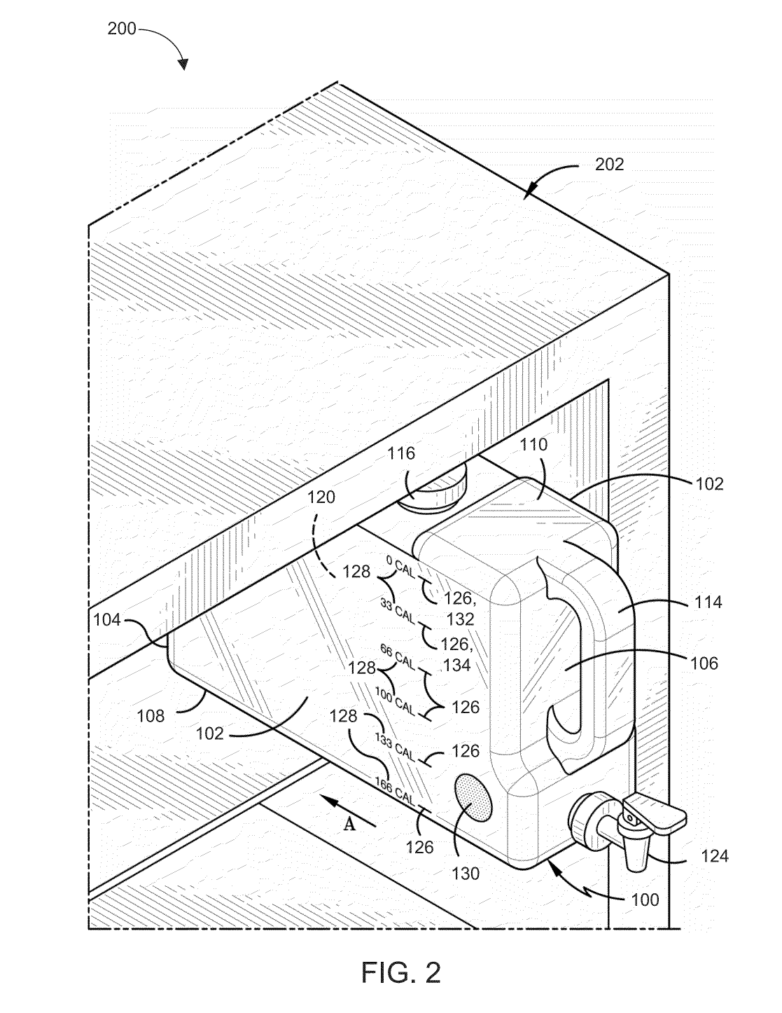

FIG. 1 depicts a container 100 of the present invention. Container 100 preferably may be formed of a clear plastic material. Container 100 may have an elongated rectangular shape with a pair of parallel spaced side walls 102, an end wall 104, a front wall 106, a bottom wall 108 and a top wall 110, all of which may provide an internal chamber 112. Preferably, a handle 114 may be formed integrally with and extend outwardly from front wall 106 to assist in placing and removing the container into and from a refrigeration unit 202, as shown in FIGS. 2-4. Container 100 may have various other configurations such as cylindrical, square, etc. without affecting the concept of the invention.

A cap 116 may be provided which closes a port 118 formed in a top portion of wall 110 of container 100. The port may facilitate filling of container 100 with an aqueous liquid. In some preferred embodiments, the aqueous liquid may be water 120. An output spigot 122 may be formed, for example, in the lower front portion of the wall. Output spigot 122 may include an ON/OFF valve 124 to facilitate dispensing of water 120 from within enclosed chamber 112.

In accordance with one of the features of the invention, a plurality of gradations 126 may be displayed on container 100, e.g., on one of the container side walls 102 and may be horizontally spaced from each other a specific distance. Plurality of gradations 126 may be configured to indicate to a user a plurality of liquid levels in enclosed chamber 112, each pair of the plurality of liquid level gradations 126 having a corresponding volume. Adjacent or proximate to at least some of the plurality of gradations 126 may be a caloric indicia 128. Gradations 126 and indicia 128 and numeric markings can be embossed or molded into the plastic material of side wall 102 or printed thereon.

A temperature indicating device 130, may incorporated into container 100. In some preferred embodiments, temperature indicating device 130 may be a liquid crystal color change indicator of a type well known in the refrigeration industry. Various other types of temperature indicating devices 130 known to the art may be employed and are contemplated within the scope of the present invention. In one embodiment, temperature indicating device 130 comprises a thermometer. In another embodiment, temperature indicating device 130 comprises a thermochromatic device, such as for example a thermochromatic sticker.

In one embodiment, container 100 comprises a dual wall, including an external wall (e.g., side walls 102) coupled to an internal wall (not shown). In another embodiment, container 100 comprises a dual wall. In another embodiment, container 100 comprises a single wall in at least one portion, and a dual wall in at least another portion. In another embodiment, container 100 comprises a dual wall in at least the area of the external wall and the internal wall adjacent to temperature indicating device 130. In another embodiment, container 100 comprises a dual wall in at least the area of the external wall and internal wall immediately surrounding to temperature indicating device 130. In another embodiment, container 100 comprises a dual wall in at least the area of the external wall adjacent to temperature indicating device 130. In another embodiment, container 100 comprises a dual wall, and temperature indicating device 130 is oriented between the external wall and the internal wall.

The dual wall may include an external wall and an internal wall. The internal wall may define an enclosed chamber configured to contain an aqueous liquid. The external wall may include the internal wall to define an insulating space between the external wall and the internal wall.

Drinking a specific amount of water, for example the volume in container 100 between indicia lines 132 and 134, when at a temperature in the range of between about 0° C. and about 5° C. may result in an individual expending about 33 kilocalories in order to raise the temperature of the consumed water to match the user's core body temperature of about 37° C. The caloric indicia may be appropriately configured, for example, to indicate that drinking a specific volume of water between gradations 126 and indicia 128 may result in expending about 33 kilocalories in order to internally heat the chilled water. The value of indicia 128 may vary depending upon the particular configuration and size of container 100, the volume of water between gradations 126, and the particular value of the first temperature as indicated by the temperature indicating device. In some examples, the water temperature may be between about 0° C. and about 5° C., an average temperature of about 2.5° C. may be assumed as the first temperature and used as the basis for the kilocalorie calculations. In some examples, the kilocalorie scale may be an approximation. In other examples, temperature indicating device 130 may be configured to indicate a different temperature range, and thus, the average temperature assumption may change. For example, temperature indicating device 130 may be configured to indicate a water temperature of between about 0° C. and about 6° C., an average temperature of about 3° C. may be assumed, and the kilocalorie calculations may be updated accordingly.

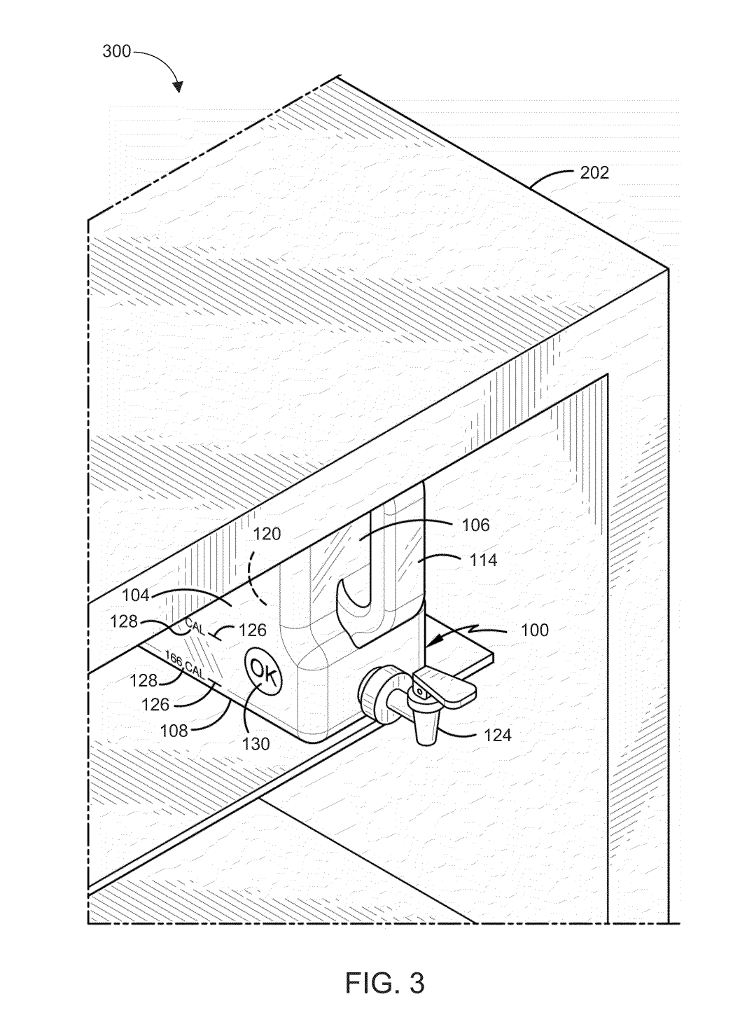

FIGS. 2-4 show various examples of using the container of the present invention. The container may be filled with a liquid, preferably water. In one embodiment, the water is at the normal temperature when discharged from a household faucet. The container may be inserted into the interior of refrigeration unit 202 as shown by arrow A in FIG. 2. After being in the refrigeration unit for a specific length of time, temperature indicator 130 may signal to an observer, as shown in FIG. 3, that the temperature of the liquid contained within container 100 has reached about or less than the first temperature, which in the preferred embodiment may be between about 0° C. and about 5° C. This may be indicated by temperature indicating device 130 providing a visual sign such as the letters “OK” appearing on the tag, by changing color, by displaying a number corresponding to the temperature, a combination, or the like. Therefore, the user may know upon opening the door of refrigeration unit 202 that the temperature of the liquid within container 100 may be at the first temperature.

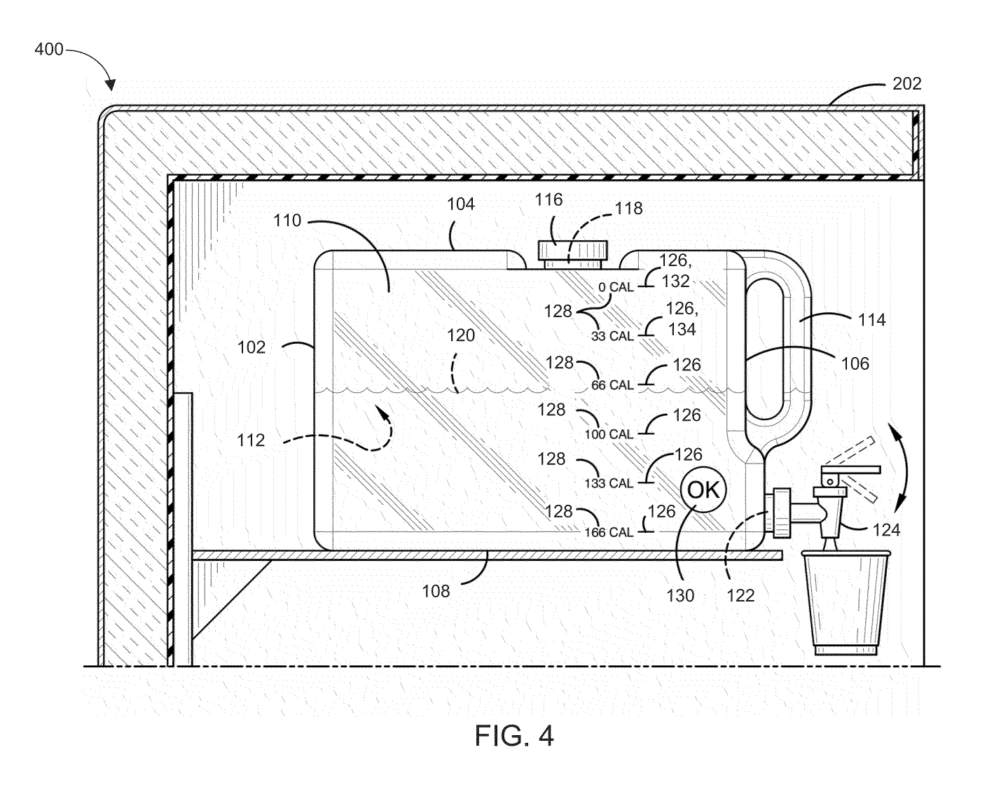

FIG. 4 shows dispensing liquid 21 from container 100 by the use of output spigot 25 with the temperature indicating device 33 still advising the user that the temperature may be at or below the first temperature.

In some examples, container 100 preferably may be formed of a transparent plastic material. In other examples, a transparent sight zone may be provided on a translucent or opaque container 100 sufficient to permit the user to see the level of liquid 120 within container 100 and its relationship to plurality of gradations 126.

In various embodiments, a user desiring to lose weight or maintain a certain weight may consume the recommended eight, 8 ounce glasses of water per day and at the same time provide the incentive of knowing that a certain amount of kilocalories may be expended by drinking each 8 ounce glass or multiple glasses of liquid throughout the day. If the individual drinks more than the recommended eight glasses of water per day, it may likewise increase the kilocalorie expenditure. The container of the present invention, together with its methods of use, facilitates this desired effect in a simple and economical manner, which may be both helpful to an individual as well as motivational in its use.

It may be readily understood that individual elements of the present invention may be rearranged or located on alternate walls or faces of container 100 without departing from the spirit of the invention. For example, handle 114 may be located on top wall 110 and gradations 126 may be located on any of the walls, including front wall 106. Temperature indicating device 130 may be located on front wall 106 or even disposed within internal chamber 112 to more accurately and directly sample the water temperature therein. Still further, while not shown in the preferred embodiment, an opening or vent hole may be provided on container 100 to allow proper air flow as water may be drained from container 100, such as to maintain a generally constant internal pressure in container 100.

One feature of the present invention may be to provide a container preferably formed of a transparent plastic material, which has a plurality of indicia markings in a spaced vertical configuration along one of the side walls of the container in combination with numeric markings specifying the amount of kilocalories which may be expended by the individual upon drinking the volume of water between each level of the indicia.

Another feature of the present invention provides a container having a temperature indicator incorporated therein, preferably in the form of a liquid crystal tag secured to the outer surface of the container by a pressure sensitive adhesive, which provides a color or visible message that the liquid contents may be within a predetermined temperature range.

A still further feature of the present invention may be to provide a clear plastic container, preferably having a fill opening at an upper portion of the container and a dispensing valve at the lower end to facilitate the filling of the container with water or other liquid and to provide an easy way of dispensing a desired quantity of liquid from the container without removing it entirely from the refrigerator or cold storage device.

These features may be obtained by the container of the present invention, the general nature of which may be stated as a container for indicating the amount of kilocalories expended by a person upon consuming a specific amount of liquid contained within the container wherein the said container includes a plurality of walls forming an internal chamber for storing the liquid, a graduated sequence of indicia on at least one of the walls so that a spacing between adjacent indicia corresponds to an amount of kilocalories expended by the person for consuming the liquid between the adjacent indicia, and a temperature indicating device displayed on the container for indicating that the temperature of the liquid may be within a certain temperature range.

These features may be further obtained by the method of the present invention, the general nature of which may be stated as a method of assisting a person in measuring the amount of kilocalories expended in drinking a specific volume of a liquid which includes the steps of providing a container for receiving a quantity of the liquid, providing a plurality of indicia on the container indicating the amount of kilocalories to be expended by the person upon consuming the volume of liquid between certain of the indicia, and providing a visual indicator on the container to indicate that the liquid may be within a certain temperature range.

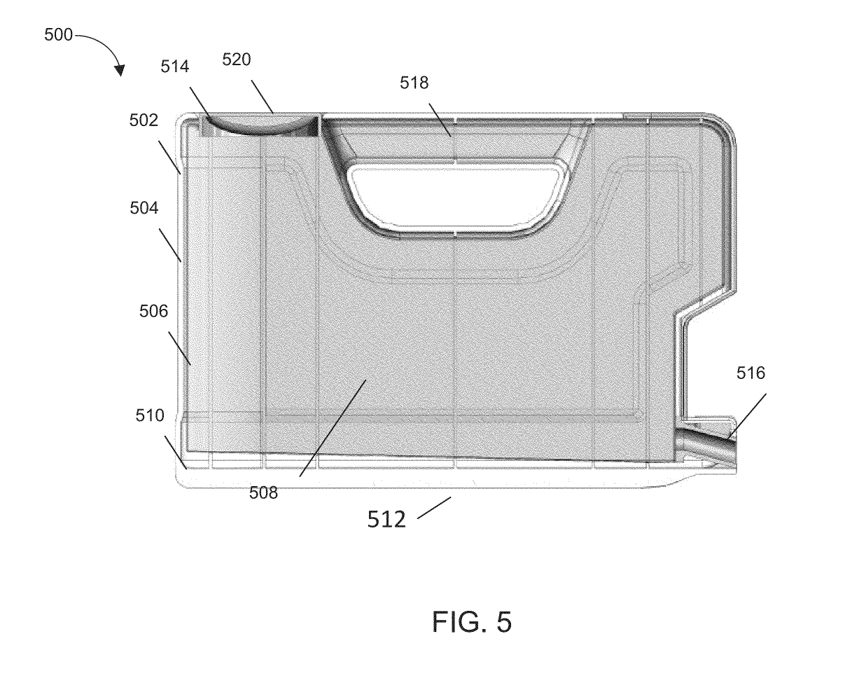

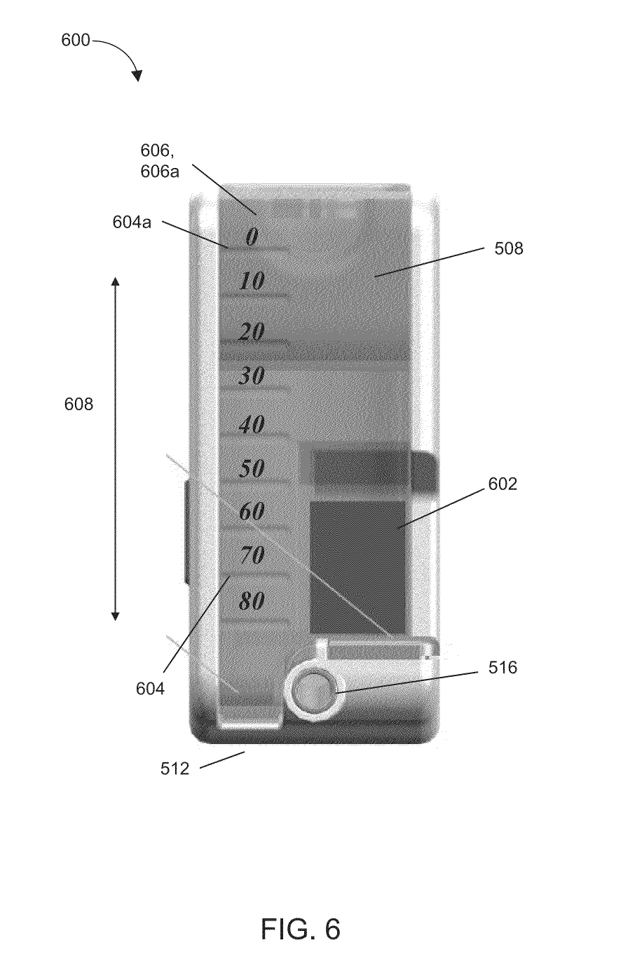

In various embodiments, a container is provided, e.g., a container 500 shown in FIG. 5. Container 500 may include a dual wall 502. Dual wall 502 may include an external wall 504 coupled to an internal wall 506. Internal wall 506 may define an enclosed chamber 508 configured to contain aqueous liquid. External wall 504 may enclose internal wall 506 to define an insulating space 510 between external wall 504 and internal wall 506. External wall 504 may include a base 512 configured to support container 500 on a surface. Container 500 may include a port 514 traversing dual wall 502 and insulating space 510. Port 514 may be configured to admit aqueous liquid from outside external wall 504 into enclosed chamber 508. Container 500 may include an output spigot 516 traversing dual wall 502 and insulating space 510. Output spigot 516 may be configured to dispense aqueous liquid contained within enclosed chamber 508 from container 500. Referring now to container 600 in FIG. 6, container 600 may include a temperature indicating device 602 displayed on container 600. Temperature indicating device 602 may be configured to indicate to a user whether a current temperature of aqueous liquid contained in enclosed chamber 508 may be at or below a first temperature value. Container 600 may include a plurality of gradations 604 displayed on container 600 and configured to indicate to a user a plurality of liquid levels in enclosed chamber 508. Each pair of plurality of liquid level gradations 604 may have a corresponding volume. Container 600 may include a plurality of caloric indicia 606 displayed in conjunction with plurality of gradations 604. Each caloric indicia 606 may display a caloric energy value corresponding to heating one or more of said corresponding volumes of aqueous liquid from the first temperature value to a second temperature value.

In some embodiments, the first temperature value may be between about 0° C. and about 37° C. The second temperature value may be about 37° C. The first temperature value may be between about 0° C. and about 5° C.

In several embodiments, plurality of gradations 604 may be displayed on container 600 along a substantially vertical axis 608 with respect to base 512 of container 600. One gradation 604a from among plurality of gradations 604 furthest from base 512 of container 600 may be associated with a caloric indicia 606a of zero.

In other embodiments, plurality of caloric indicia 606 may increase incrementally in positive numerical value along substantially vertical axis 608 towards base 512 of container 600.

Referring again to FIG. 5, in various embodiments, output spigot 516 may be located in proximity to base 512 of container 500. Output spigot 516 may be configured to dispense aqueous liquid from enclosed chamber 508 under the influence of gravity when container 500 may be set upon base 512.

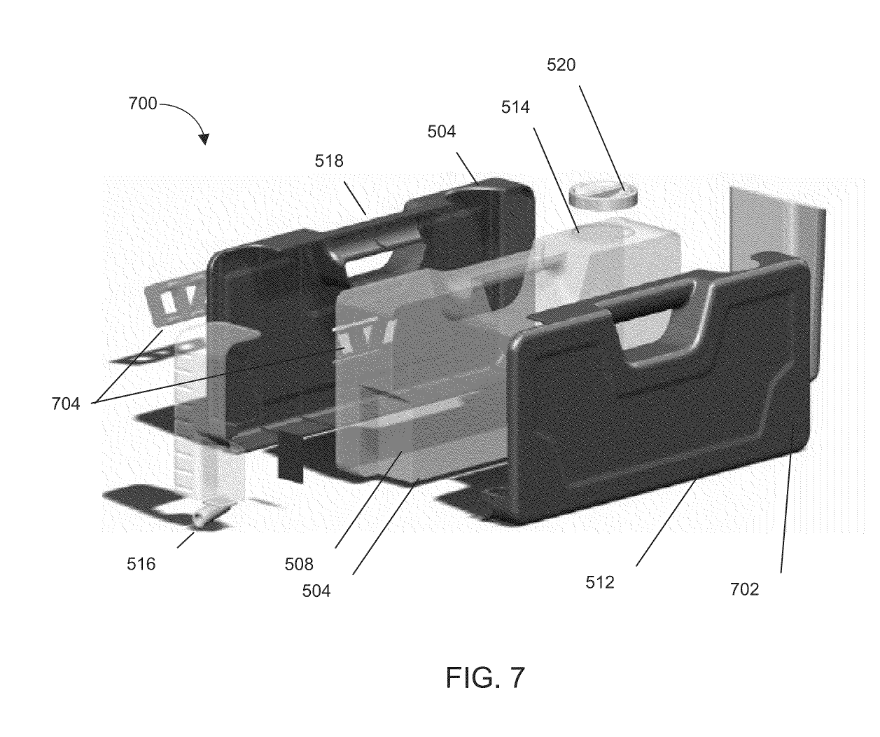

Referring again to FIG. 5, in some embodiments, external wall 504 may define at least one handle 518 configured for carrying container 500. Port 514 may include a cap 520 configured to close access to enclosed chamber 508 through port 514. Cap 520 may include a pressure equalization vent. The pressure equalization vent may be configured with a backflow mechanism or other spill prevention mechanism. Referring to FIG. 7, external wall 504 may include one or more substantially flat sides 702 configured for packing container 500 proximate to an adjacent flat side of another container or a wall.

In several embodiments, a container is provided, e.g., container 500. Container 500 may include dual wall 502. Dual wall 502 may include external wall 504 coupled to internal wall 506. Internal wall 506 may define enclosed chamber 508 configured to contain aqueous liquid therein. External wall 504 may enclose internal wall 506 to define insulating space 510 between internal wall 506 and external wall 504, and external wall 504 including base 512 configured to support container 500 on a surface. Container 500 may include port 514 traversing dual wall 502 and insulating space 510. Port 514 may be configured to convey aqueous liquid between enclosed chamber 508 and the outside of container 500.

Container 600 may include temperature indicating device 602 displayed on container 600. Temperature indicating device 602 may be configured to indicate to a user whether a current temperature of aqueous liquid contained in enclosed chamber 508 may be at or below a first temperature. For example, the first temperature may be below about 37° C. Container 600 may include plurality of gradations 604 displayed on container 600 and configured to indicate to a user a plurality of liquid levels in enclosed chamber 508. Each pair of plurality of liquid level gradations 604 may have a corresponding volume. Container 600 may include plurality of caloric indicia 606 displayed in conjunction with plurality of gradations 604. Each caloric indicia 606 may display a caloric energy value corresponding to heating one or more of said corresponding volumes of aqueous liquid from the first temperature to about 37° C. Referring to FIG. 7, container 700 may include a vent 704 located in external wall 504. Vent 704 may be operable to control an exchange of air between insulating space 510 and the atmosphere outside external wall 504. Vent 704 may be operable to modulate an insulating value of insulating space 510.

In some embodiments, the first temperature value may be between about 0° C. and about 37° C. The second temperature value may be about 37° C. The first temperature value may be between about 0° C. and about 5° C.

In several embodiments, plurality of gradations 604 may be displayed on container 700 along substantially vertical axis 608 with respect to base 512 of container 700. One gradation 604a from among plurality of gradations 604 furthest from base 512 of container 700 may be associated with a caloric indicia 606a of zero.

In other embodiments, plurality of caloric indicia 606 may increase incrementally in positive numerical value along substantially vertical axis 608 towards base 512 of container 700.

In various embodiments, output spigot 516 may be located in proximity to base 512 of container 700. Output spigot 516 may be configured to dispense aqueous liquid from enclosed chamber 508 under the influence of gravity when container 700 may be set upon base 512.

In some embodiments, external wall 504 may define at least one handle 518 configured for carrying container 700. Port 514 may include cap 520 configured to close access to enclosed chamber 508 through port 514. External wall 504 may include one or more substantially flat sides 702 configured for packing container 700 proximate to an adjacent flat side of another container or a wall.

In some embodiments, a kit is provided. The kit may include container 500 and instructions.

The kit may include any embodiment of container 500 described herein. For example, in the kit, container 500 may include dual wall 502 including external wall 504 coupled to internal wall 506. Internal wall 506 may define enclosed chamber 508 configured to contain aqueous liquid. External wall 504 may enclose internal wall 506 to define insulating space 510 between external wall 504 and internal wall 506. External wall 504 may include base 512 configured to support container 500 on a surface. Container 500 may include port 514 traversing dual wall 502 and insulating space 510. Port 514 may be configured to convey aqueous liquid between enclosed chamber 508 and the outside of container 500. Container 500 may include temperature indicating device 602 displayed on container 500. Temperature indicating device 602 may be configured to indicate to a user whether a current temperature of aqueous liquid contained in enclosed chamber e may be at or below a first temperature. The first temperature may be below about 37° C. Container 500 may include plurality of gradations 604 displayed on container 500 and configured to indicate to a user a plurality of liquid levels in enclosed chamber 508. Each pair of plurality of liquid level gradations 604 may have a corresponding volume. Container 500 may include plurality of caloric indicia 606 displayed in conjunction with plurality of gradations 604. Each caloric indicia 606 may display a caloric energy value corresponding to heating one or more of the corresponding volumes of aqueous liquid from the first temperature to about 37° C.

In the kit, the instructions may be displayed on one or more of container 500, an instructional sheet provided with container 500, and/or a packaging material for container 500. The instructions may direct a user to add an aqueous liquid to container 500. The instructions may direct a user to cool container 500 below about 37° C. until the temperature indicator indicates that the current temperature of aqueous liquid contained in enclosed chamber 508 may be at or below the first temperature. The instructions may direct a user to consume the aqueous liquid at or below the first temperature.

In various embodiments, the instructions may include directing the user to monitor or record cumulative caloric energy debt. The cumulative caloric energy debt may correspond to the aqueous liquid consumed by the user, e.g., according the volume and the temperature of the aqueous liquid.

In some embodiments, the instructions may include directing the user to consume the aqueous liquid at or below the first temperature in sufficient volume to accumulate a total caloric energy debt of at least about 50 kilocalories per day. In some embodiments, the total caloric energy debt in kilocalories may be between about 5 and about 250, about 10 and about 200, about 25 and about 150, about 50 and about 130, or about 50 and 100. In some embodiments, the total caloric energy debt in kilocalories may be about 5, 10, 25, 35, 50, 60, 75, 100, 125, 150, 175, 200, 225, or 250.

In several embodiments, the instructions may include directing the user to cool container 500 to between about 0° C. and about 5° C. In some embodiments, container 500 and/or liquid contained therein may be cooled to a temperature in ° C. of about 0, 1, 2, 3, 4, 5, 10, 15, 20, 25, 30, or 35. In some embodiments, for example, when the aqueous liquid may include freezing point depressing solutes such as flavorants, minerals, vitamins, sugars, reduced calorie sweeteners, soluble antifreeze proteins, or other edible solutes, container 500 and/or liquid contained therein may be cooled to a temperature in ° C. below 0, for example, about −1, −2, −3, −4, −5, −6, −7, −9, −9 or −10.

In various embodiments of the kit, container 500 may include vent 704 located in external wall 504. The instructions may include directing the user to open vent 704 while cooling to admit cool air into insulating space 510 thereby reducing an insulating value of insulating space 510. For example, the instructions may direct the user to open vent 704 upon placing container 500 in a refrigerator so as to increase the speed of cooling. The instructions may include directing the user to close vent 704 after cooling to increase the insulating value of insulating space 510. For example, the instructions may direct the user to close vent 704 after cooling to insulate the cooled liquid in enclosed chamber 508 during transport.

In various embodiments, the instructions may include instructions directing a user to conduct any operation, method, or step described herein with respect to container 500, such as: cooling, filling, or cleaning container 500; or incorporating the consumption of the aqueous liquid and corresponding caloric energy debt in a diet or program of physical fitness.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See Bryan A. Garner, A Dictionary of Modern Legal Usage 624 (2d. Ed. 1995). Also, to the extent that the terms “in” or “into” are used in the specification or the claims, it is intended to additionally mean “on” or “onto.” To the extent that the term “selectively” is used in the specification or the claims, it is intended to refer to a condition of a component wherein a user of the apparatus may activate or deactivate the feature or function of the component as is necessary or desired in use of the apparatus. To the extent that the term “operatively connected” is used in the specification or the claims, it is intended to mean that the identified components are connected in a way to perform a designated function. As used in the specification and the claims, the singular forms “a,” “an,” and “the” include the plural. Finally, where the term “about” is used in conjunction with a number, it is intended to include ±10% of the number. In other words, “about 10” may mean from 9 to 11.

As stated above, while the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art, having the benefit of the present application. Therefore, the application, in its broader aspects, is not limited to the specific details, illustrative examples shown, or any apparatus referred to. Departures may be made from such details, examples, and apparatuses without departing from the spirit or scope of the general inventive concept.

What is claimed is:

1. A container, comprising:
a dual wall comprising an external wall coupled to an internal wall,
wherein the internal wall defines an enclosed chamber configured to contain an aqueous liquid therein,
wherein the external wall encloses the internal wall to define an insulating space therebetween, and
wherein the external wall includes a base configured to support the container on a surface;
a port traversing the dual wall and the insulating space, wherein the port is configured to admit the aqueous liquid from outside the external wall into the enclosed chamber;
an output spigot traversing the dual wall and the insulating space, wherein the output spigot is configured to dispense the aqueous liquid contained within the chamber from the container;
a temperature indicating device displayed on the container, wherein the temperature indicating device is configured to indicate to a user whether a current temperature of the aqueous liquid contained in the chamber is at or below a first temperature value;
a plurality of gradations displayed on the container and configured to indicate to a user a plurality of liquid levels in the enclosed chamber, wherein each pair of the plurality of liquid level gradations has a corresponding volume; and
a plurality of caloric indicia displayed in conjunction with the plurality of gradations, wherein each caloric indicia displays a caloric energy value corresponding to heating one or more of the corresponding volumes of aqueous liquid from the first temperature value to a second temperature value.

2. The container of claim 1, wherein the first temperature value is between about 0° C. and about 37° C. and the second temperature value is about 37° C.

3. The container of claim 1, wherein the first temperature value is between about 0° C. and about 5° C.

4. The container of claim 1, wherein the plurality of gradations are displayed on the container along a substantially vertical direction with respect to the base of the container.

5. The container of claim 1, wherein a gradation from among the plurality of gradations furthest from the base of the container is associated with a caloric indicia of zero.

6. The container of claim 1, wherein the plurality of caloric indicia increases incrementally in positive numerical value along a substantially vertical direction towards the base of the container.

7. The container of claim 1, wherein the output spigot is located in proximity to the base of the container and the output spigot is configured to dispense aqueous liquid from the enclosed chamber under the influence of gravity when the container is set upon the base.

8. The container of claim 1, wherein the external wall defines at least one handle configured for carrying the container.

9. The container of claim 1, wherein the port includes a cap configured to close access to the enclosed chamber through the port.

10. The container of claim 1, wherein the external wall includes one or more substantially flat sides configured for packing the container proximate to an adjacent flat side of another container or a wall.

11. A container, comprising:
a dual wall comprising an external wall coupled to an internal wall,
wherein the internal wall defines an enclosed chamber configured to contain aqueous liquid therein,
wherein the external wall encloses the internal wall to define an insulating space therebetween, and
wherein the external wall includes a base configured to support the container on a surface;
a port traversing the dual wall and the insulating space, wherein the port is configured to convey aqueous liquid between the enclosed chamber and outside the container; and
a vent located in the external wall, wherein the vent is operable to control an exchange of air between the insulating space and an atmosphere outside the external wall to modulate an insulating value of the insulating space.

12. The container of claim 11, further comprising:
a temperature indicating device displayed on the container, wherein the temperature indicating device is configured to indicate to a user whether a current temperature of aqueous liquid contained in the chamber is at or below a first temperature,
wherein the first temperature is below about 37° C.;
a plurality of gradations displayed on the container, wherein the plurality of gradations are configured to indicate to a user a plurality of liquid levels in the enclosed chamber, and wherein each pair of the plurality of liquid level gradations has a corresponding volume; and
a plurality of caloric indicia displayed in conjunction with the plurality of gradations, wherein each caloric indicia displays a caloric energy value corresponding to heating one or more of said corresponding volumes of aqueous liquid from the first temperature to about 37° C.

13. The container of claim 12, wherein the plurality of caloric indicia increase incrementally in positive numerical value along a substantially vertical direction towards the base of the container.

14. The container of claim 11, wherein the external wall defines at least one handle configured for carrying the container.

15. The container of claim 11, wherein the external wall includes one or more substantially flat sides configured for packing the container proximate to an adjacent flat side of another container or a wall.

16. A kit, comprising:
a container, comprising:
a dual wall comprising an external wall coupled to an internal wall,
wherein the internal wall defines an enclosed chamber configured to contain aqueous liquid therein,
wherein the external wall encloses the internal wall to define an insulating space therebetween, and
wherein the external wall includes a base configured to support the container on a surface;
a port traversing the dual wall and the insulating space, wherein the port is configured to convey aqueous liquid between the enclosed chamber and outside the container;
a temperature indicating device displayed on the container, wherein the temperature indicating device is configured to indicate to a user whether a current temperature of aqueous liquid contained in the chamber is at or below a first temperature, the first temperature being below about 37° C.;
a plurality of gradations displayed on the container and configured to indicate to a user a plurality of liquid levels in the enclosed chamber, wherein each pair of the plurality of liquid level gradations has a corresponding volume;
a plurality of caloric indicia displayed in conjunction with the plurality of gradations, wherein each caloric indicia displays a caloric energy value corresponding to heating one or more of said corresponding volumes of aqueous liquid from the first temperature to about 37° C.; and
instructions displayed on one or more of the container, an instructional sheet provided with the container, and/or a packaging material for the container, wherein the instructions direct a user to:
add an aqueous liquid to the container;
cool the container at below about 37° C. until the temperature indicator indicates that the current temperature of aqueous liquid contained in the chamber is at or below the first temperature; and
consume the aqueous liquid at or below the first temperature.

17. The kit of claim 16, wherein the instructions include directing the user to monitor or record cumulative caloric energy debt corresponding to the aqueous liquid consumed by the user.

18. The kit of claim 16, wherein the instructions include directing the user to consume the aqueous liquid at or below the first temperature in sufficient volume to accumulate a total caloric energy debt of at least about 50 kilocalories per day.

19. The kit of claim 16, wherein the instructions include directing the user to cool the container to between about 0° C. and about 5° C.

20. The kit of claim 16, wherein the container includes a vent oriented in the external wall and the instructions include directing the user to:
open the vent while cooling to admit cool air into the insulating space thereby reducing an insulating value of the insulating space; and
close the vent after cooling to increase the insulating value of the insulating space.
